(19) United States
(12) Patent Application Publication
(10) Pub. No.: US 2011/0155715 A1
(43) Pub. Date: Jun. 30, 2011

(54) Radiant Heater Device

(76) Inventor: Arthur D. Kaesler, Martinsville, NJ (US)

(21) Appl. No.: 12/930,998

(22) Filed: Jan. 22, 2011

Related U.S. Application Data
(63) Continuation-in-part of application No. 11/633,395, filed on Dec. 4, 2006, now Pat. No. 7,935,911.
Application No. 11/633,395 is a division of application No. 10/814,709, filed on Mar. 31, 2004, now Pat. No. 7,170,033.
(60) Provisional application No. 60/461,025, filed on Apr. 4, 2003.

(51) Int. Cl. H05B 3/02; H01C 17/02

(52) U.S. Cl. 219/481; 219/548; 29/611

(57) ABSTRACT

The invention relates to constructing a heating device that employs electrical resistance foils to provide a uniform heat. In embodiments of the invention applicable for providing heat from a ceiling location, the device provides this uniform heat at a comfortable temperature.

### CROSS-REFERENCE TO RELATED APPLICATIONS

This application is a Continuation-in-Part of U.S. application Ser. No. 11/633,395, filed Dec. 4, 2006; which is a Divisional Application of Ser. No. 10/814,709, filed Mar. 31, 2004 and issued as U.S. Pat. No. 7,170,033 on Jan. 30, 2007; which in turn claims priority to U.S. Provisional Application Ser. No. 60/461,025 filed Apr. 4, 2003. The contents of each of these references are expressly incorporated herein by reference.

### FIELD OF THE INVENTION

The present invention relates to electrically powered heating devices, and more particularly to such devices for use in ceilings as a localized heat source.

### BACKGROUND OF THE INVENTION

Electrically powered heating devices have long been known and used for generating heat for various purposes, and through the course of their development such devices have become quite sophisticated and specialized for particular purposes. The present invention provides a new member of this class of device that is particularly adapted for use for providing a uniform heating source.

The configurational embodiment of heated devices is critical to their practical utility and has not been well addressed by prior devices. When used as a heating mat, such a mat should be relatively thin to not significantly interfere with the activities of the users. That is, for use in an area in which one stands or sits, the thickness should not create a safety problem by creating a potential for tripping or twisting one's ankle. Further, the mat should be particularly resilient to wear in such an environment where foot traffic and/or chair movement is concentrated on sections of the mat surface. Moreover, where such activity does eventually cause wear in the surface of the mat, visual cues should be provided when that wear has occurred to the point where it potentially causes a problem with the electrical integrity of the mat. The mat should be sufficiently durable to withstand damage which may occur from users wearing stiletto shoes or high heels, or from accidentally dropping a heavy or sharp object. And perhaps most importantly, the mat should be so constructed that the individual user is protected from electrical shock should the electrical circuit of the mat be damaged.

When used as a localized heat source for deployment in a ceiling, such a device should be relatively thin and light to find practical uses such as replacement units for ceiling tiles. That is, such a radiant ceiling heater, optimally should be designed to fit in place of a ceiling tile on a grid system and thereby provide a heater source to provide heat to a local area such as a desk work area, a hospital bed, etc.

Functionally, prior heating devices have experienced difficulties in providing uniform heat at a temperature comfortable to individual users and/or within localized areas. The present invention overcomes these shortcomings of the prior art by providing a heating device structure which comprises a heating element that is formed of electrically resistive foil that is contained in protective layers of chopped strands. Additional embodiments of the invention when deployed in a ceiling, further comprise aluminum covers.

### SUMMARY OF THE INVENTION

The heating device structure of the present invention employs electrical resistance foils to provide a uniform, comfortable heat to individuals and/or to localized areas.

### BRIEF DESCRIPTION OF THE DRAWINGS

Various embodiments of the present invention will now be described in detail in conjunction with the annexed drawings, in which:

FIG. 1a is a partially cut-away view of the invention showing its top surface as well as various component layers of the heating device according to one embodiment of the invention;

FIG. 1b is a partially cut-away side view of the embodiment of the invention depicted in FIG. 1a;

FIGS. 2a and 2b are perspective top surface view showing the overall appearance of the heating device according to embodiments of the invention for use as ceiling tile replacements;

FIG. 3 illustrates an exemplary thermostat for use with the invention; and,

FIG. 4 is a partially cut-away view of an embodiment of the heating blanket of the present invention.

### DETAILED DESCRIPTION

The present invention is a Radiant Heater Device that is both relatively thin and light. It is particularly suitable for use in place of a ceiling tile on a grid system. The device can be readily constructed in 24″×24″ (Actual 23.75″×23.75″) or 24″×48″ (Actual 23.75″×47.75″) dimensions for this ceiling use. They can also be custom designed to fit in the grid system of drop ceilings for use under awnings, over entrance ways to department stores, hotel entrances, etc.

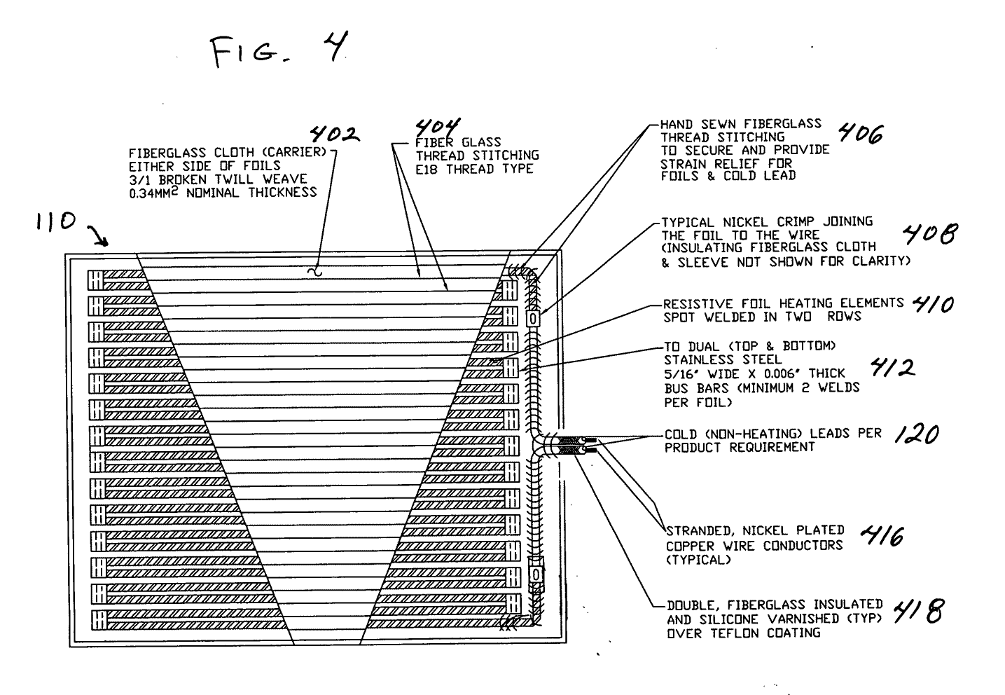

The present invention is an electrically powered heating device. The heater relies on an alternative current voltage being applied to electrical resistance foils that are in a series/parallel configuration in the device's heating element blanket. Such an embodiment of the invention is depicted in FIG. 4 and will be discussed in greater detail below.

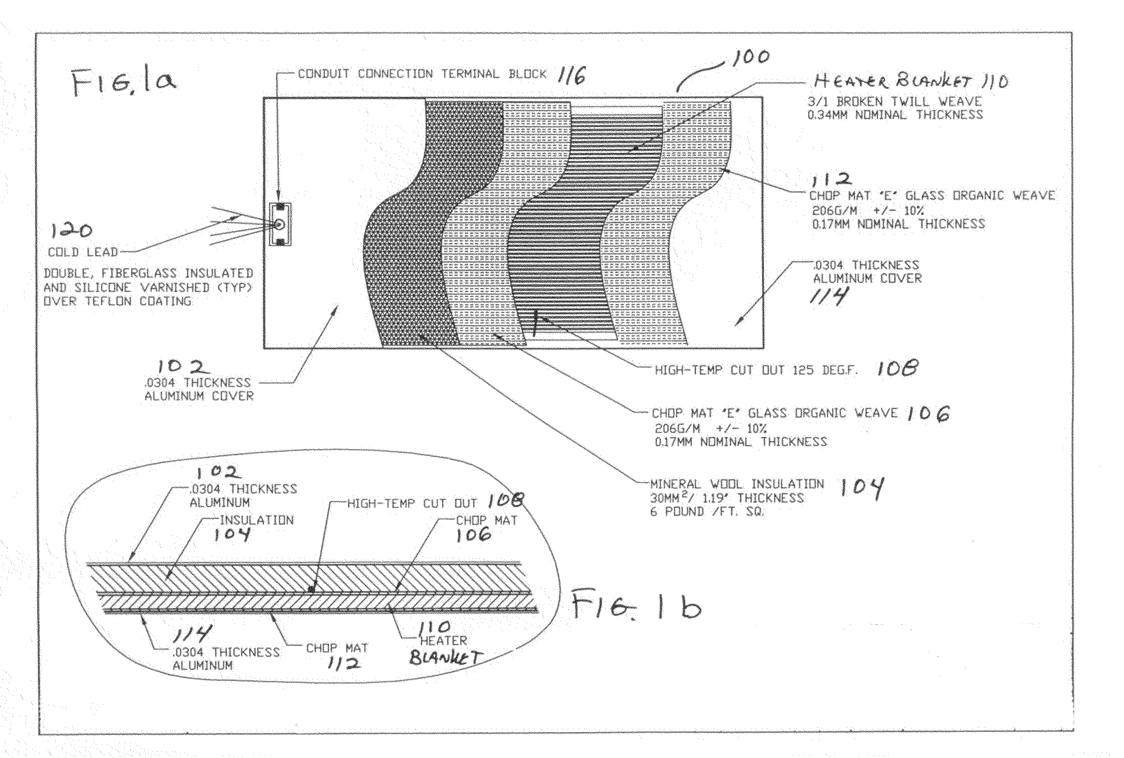

In the embodiment illustrated in FIGS. 1a and 1b, the heating device 100 is designed from a flat foil element sewn into a fiberglass cloth that keeps the foils separated and encloses them between the fiberglass to form a heating element blanket 110. By doing this, the foils are prevented from ever touching and arcing.

FIG. 4 illustrates an exemplary heating element blanket of the invention wherein foil elements 410 are sewn between two fiberglass cloths 402 using fiberglass thread stitching 404. In one embodiment, each such fiberglass layer is approximately 0.01″ in thickness and the sewing procedure creates pockets in which the foil elements reside. Thus in the manufacturing of such a blanket, the foil elements are not damaged by the sewing procedure. In further embodiments of the invention it is envisioned that rows of such pockets would be created, such rows spaced approximately 0.125″ apart. It is further contemplated that the mechanism for creating this blanket would create 20 such pockets per pass.

In an additional embodiment of the invention the foil 410 is an 80/20 Nichrome foil 80% Nickel and 20% Chrome, this particular make-up makes for a superior heater. In further embodiments, these foil resistance elements are of width not greater than 0.125″ and thickness not greater than 0.005″. The terminations of these elements are done using a Stainless Steel ⅜″ Strip or Buss bar 412 welded onto the foils' top and bottom and then trimmed and terminated to suit. In a further embodiment, the High-Temperature leads are then added on, using a High Temperature Nickel Crimp 408. Additional electrical elements, insulation, and strain relief stitching (items 120 & 416, 418, and 406, respectively) are also illustrated in FIG. 4. It is contemplated that with such an arrangement, the heating element blanket itself can withstand up to 1150 Deg.F. The temperature range for the device itself can readily withstand temperatures of up to 400 Deg.F. However, in normal use and as discussed below, the heating device operates at temperatures below 125 Deg. F.

Returning to the embodiment depicted in FIG. 1a, a connection box 116 is depicted whereby power is supplied to the heating device 100. FIGS. 1a and 1b further depict the presence of aluminum covers on top and bottom (items 102 and 114, respectively). In particular, in an embodiment of the invention for use in a ceiling application, the heater's lower cover 114 will be made up of a Powder Coated aluminum/stainless tray that will be visible on the ceiling. As illustrated in the embodiment depicted in FIG. 1b, there are two layers of chop mat fiberglass 106 and 112 adjacent to the heating element blanket 110. An insulation layer 104 is then placed on top of chopped mat 106 to direct the heat downward. It should be noted that in alternative embodiments of the invention, chop mat 106 can be deleted; in which case the insulation layer 104 directly abuts the heating element blanket 110.

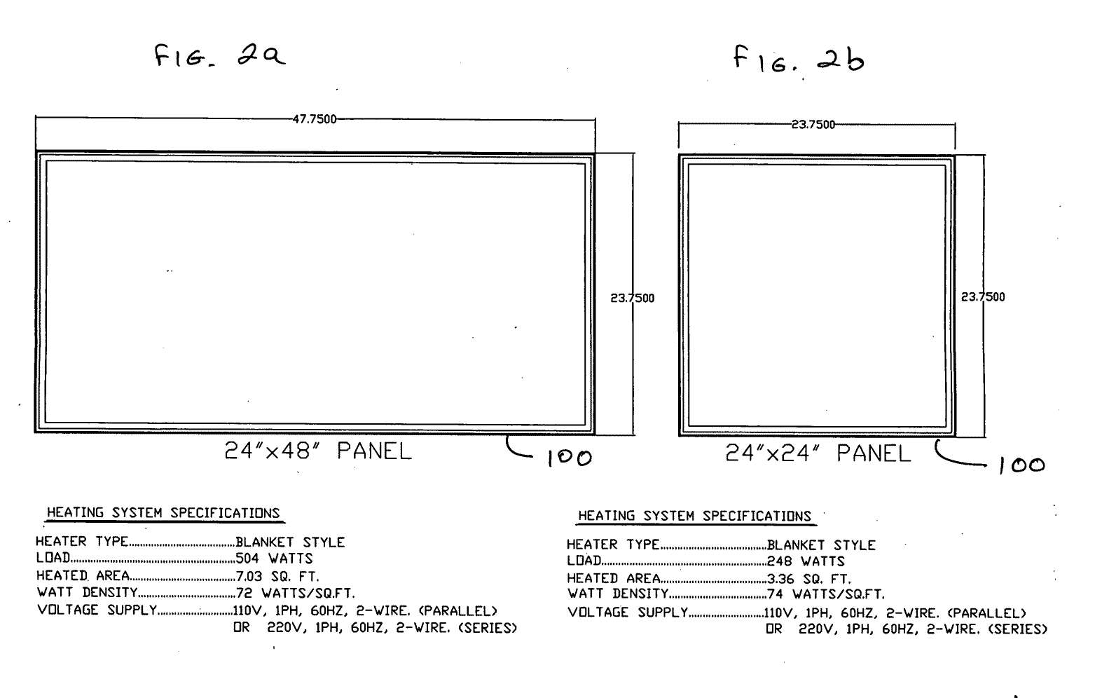

FIGS. 1a and 1b further illustrate an optional feature of the invention, the presence of a high-temperature cut out 108. In one embodiment this high-temperature cut out is set at 125 Deg.F. As noted above, while the heating device of the present invention can function at significantly higher temperatures (e.g. 400 Deg.F.), the device is typically designed to perform when the temperature of the heating blanket is approximately 115 Deg.F. The embodiments of the invention depicted in FIGS. 2a and 2b relate to a heating device for use as replacement for standard-sized ceiling tiles. As illustrated for each of these embodiments, the device is designed with a particular Watt Density. As a result, in normal operations in a room with a normal ambient temperature, the heating blanket performs at approximately 115 Deg.F. In the event the room temperature becomes excessive (e.g., in excess of 85 Deg.F.) the internal temperature of the heating blanket would be effected. The high-temperature cut out feature 108 is a snap switch that is designed to function in this situation. That is, when such a switch is set at 125 Deg.F., the heater will turn off once that temperature is reached—independently of any action by a user in regulating the heating device by a thermostat. In a further embodiment, once the heating blanket temperature drops below 115 Deg.F., the heating device will again be capable of functioning to provide heat.

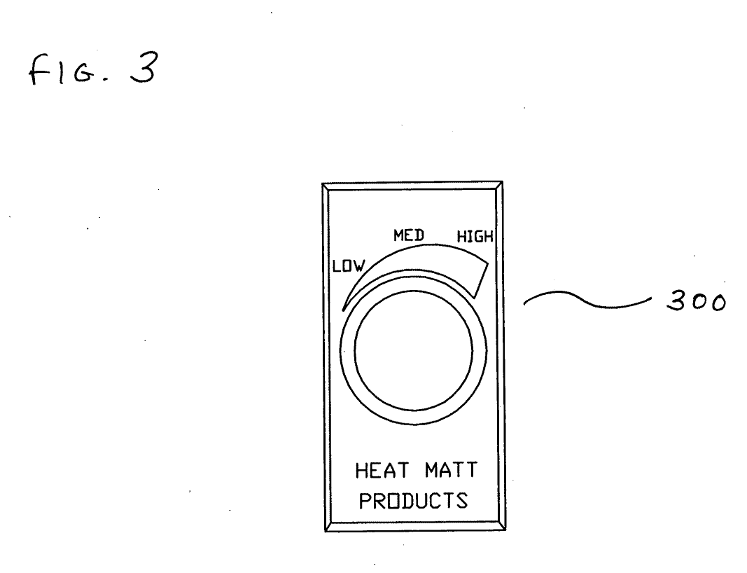

It should be noted that the invention is not limited to the above embodiments. As noted above, the heating device can be made to various custom sizes. Further, the power output of the heater can be customized for various climatic conditions. As an example, FIGS. 3a and 3b illustrate dimensions and specifications of embodiments of the invention that are applicable as ceiling heaters that replace conventional size ceil tiles.

Still further, the color of the outermost layer can be color coordinated to the surrounding décor. Additional embodiments of the invention include a thermostatic control for use in controlling the temperature of the area being heated. FIG. 3 illustrates an example of such a thermostatic control 300 which can be a conventional wall mounted thermostat as well as a hand held remote control device for use by individuals in the local area heated by the invention (to adjust temperature, turn device on/off).

As described above, the radiant heating device 100 of the present invention can be thought of in terms of a heating element blanket 110 (also reference below as the heating mat), and the radiant heating device 100 itself. An embodiment of each of these will each be described in more detail, as well as a description of a typical method of construction for assembly and inspection of a radiant heating device embodiment of the present invention. That is, the following detail is merely exemplary and is not meant to impose any limitations on the device structure or its construction method.

### I. Heating Element Blanket

Heating Elements 80/20 Nickel Chromium Alloy

Element Carrier EKC 161 Glass Fabric or similar
(two layers)

Sewing Thread Glass fiber sewing thread type E18

Termination Strip 0.006″×0.312″ 304 stainless steel strip
(two layers)

Internal Bridge Insulation 25 mm×0.25 mm E Grade Woven Glass Tape
(two layers)

Cold Leads 2 core 30/0.25 mm Nickel plated copper
Double Glass lapped and varnished

Crimp Type Splice AMP type 322347

The fabric to act as the heating element carrier is fiberglass cloth up to 7″ wide widths. The width depends on the heater being constructed.

Two strips of the fabric are placed onto the multi-needle sewing machine along with the required number of reels of foil heating element. The cloth strips are passed through guides to keep them in the correct position throughout the sewing process. The heating elements are then passed through their individual guides and into the pockets. When all elements are correctly placed in their pockets, the heating mat is sewn.

Using the data supplied on the working drawings, the heating mats are cut to length. There might be more than one strip of mat to make up a complete heating mat, and in this case, the required number of lengths are cut and then machine-sewn together to achieve the required width of heating mat.

When the blank heating mat is available, it is marked with permanent marker to show:
a. Heater ref, i.e. A1, C2, D4, etc.
b. Nominal heater resistance
c. Cold lead length
d. Termination details, i.e., series or parallel connections
e. Heated length (marked with two red lines)
f. Overall Length (marked with two blue lines)
g. Any surplus foils to be removed (marked with a red line along the foils in question)
h. The foils onto which the cold leads attach (marked with blue lines along their length)

In one embodiment of the construction method, one would then take a fully, marked-up heater and unpick and remove the glass stitches to the red lines that indicate the heated length. Fold back the upper and lower layer of glass cloth to expose the heating elements. Pin the cloth to back to allow the spot welding operation to be carried out on the bridging strips. The foils that are identified as the foils onto which the cold leads are connected, should also be folded back and pinned down to prevent them being incorporated into the bridges.

To complete the bridges, a layer of bridging strip is placed above, and one below, the heating foils. To complete the connection between the foils and the two strips of bridging material, two spot welds are made through the bridging strips and the heating foil. This procedure is repeated on all heating foils until they are all securely fixed to the bridges.

When the bridging strips are fully applied, the correct electrical terminations are made by snipping the bridges at relevant positions to create the correct pattern of connections. The electrical resistance of the heater is now tested to ensure that it has the correct value and that the electrical connections are sound. This is achieved by manipulation of all bridges whilst the test instrument is attached to the cold lead connections. No fluctuations in excess of 0.1 ohms are acceptable.

When the ohmic value has been checked and found to be within the manufacturing tolerances, electrical insulation materials are applied between adjacent banks of foil to ensure that they cannot come into contact with each other. This is achieved by interweaving two thicknesses of 1″ wide glass fiber tape between the banks of foils and then sewing down the glass tape to prevent any movement.

At the end of the heating mat, where there are NO cold leads, the two layers of glass fabric are sewn together along the blue marked line.

The cold leads are now cut to length, allowing an amount equal to the width of the finished heater onto the required lead length to enable the leads to run across the width of the heater. The Heater leads will be 24″ for all heating mats

Take the prepared cold lead, and offer it up to the heating mat at the cold lead end and trim off any excess length of the cores. Place a 1″ long piece of 6 mm bore glass sleeving onto each core, then strip off ⅜″ of the glass insulation from each core. The foils onto which the cold leads are to be connected, should now be bent at right angles towards the middle of the end of the heater mat. Slide a crimp connector onto each foil/foils and insert the stripped cores of the cold lead into the crimps, and then crimp each connector, in turn, until the ratchet mechanism of the crimping tool release, thus ensuring that a full crimped connection is attained.

Slide the glass sleeves over the crimped connections and sew in place. Then sew down the cold leads to help with strain relief. Finally, sew the two layers of cloth together along the blue lines.

Reconnect the cold leads to a test meter and check the ohmic value, repeating the manipulation test as previously described, to check for fluctuations of resistance. When testing is completed, place finished heating mat in storage rack, awaiting final assembly into a module.

### II. Construction and Assembly of Exemplary Ceiling Radiant Heating Device (“RH Radiant Heater”)

The metal work of the RH Radiant Heater consists of two parts:
The Aluminum bottom tray 20 gauge powder coated
The Aluminum top Tray, 22 gauge aluminum

### Aluminum Bottom Tray

The aluminum trays are produced from a rectangular flat, 22 ga aluminum sheet, that is plastic coated on one side only. This plastic acts as a shield to protect the metal from minor scratches during production, and is removed from the finished product at final inspection. The tray is produced 1.5″ larger in both directions than actually needed after this is done there is a ¾″ notch removed from each corner. Then the Trays are bent up at the ¾″ line to produce a tray. The bottom tray is then Powder Coated to the color specified by the client.

### Aluminum Top Tray

The aluminum trays are produced from a rectangular flat, 22 ga aluminum sheet, that is plastic coated on one side only. This plastic acts as a shield to protect the metal from minor scratches during production, and is removed from the finished product at final inspection. The tray is produced 1.4″ larger in both directions than actually needed after this is done there is a ¾″ notch removed from each corner. Then the Trays are bent up at the ¾″ line to produce a tray.

Note: The reason that the top tray is 0.1″ smaller is to allow it to fit into the bottom tray for a snug fit.

Select the tray blanks which have been supplied 1½″ larger than the finished module along their width and breadth. I.E., 47¾″×23¾″ Heaters require 49¼″×25¼″ blanks.

Mark the heater reference and the bushing location as per the job drawing on the plastic coated side.

Punch the four corners to create four square notches (¾″×¾″), and punch out a hole for the leads as well as the Aluminum Conduit Box.

Bend the four ¾″ edges of the blank to form a tray with the plastic on the outside surfaces.

Place the corresponding Tray inside the tray to check the fit and alignment.

Place the properly fitting Tray-on-tray in storage awaiting final HB assembly.

### Assembly

During assembly of HB Modules, always handle the product with care to reduce the amount of scratches on the finished product.

Take heater mat from storage rack ensuring that correct reference number is shown on mat.

Collect aluminum upper tray and lower tray from storage rack, ensuring that the reference number corresponds with the heating mat on the assembly bench.

Place metalwork and heating mat on the assembly bench.

Proceed to cutting table and cut two (2) pieces of glass cloth 3″ larger in its length and breadth than the size of the tray procured.

Take the two pieces of glass two to the assembly table while ensuring that there are no particles on the table that could have a detrimental effect on the efficiency of the heater assembly, particularly metal fragments.

Take the Bottom aluminum tray and place it on the table so that the flat, flanged face is in contact with the table top.

Place the two (2) layers of glass cloth on top of the bottom aluminum tray, ensuring that the surplus fabric is evenly distributed around the edges.

Carefully snip the layers of fabric at the four corners, in order, so they can fold properly in the corners of the frame.

Take the heating mat and check that it has the correct length of lead 18-24″.

Place the heater mat into the assembly on top of the glass cloth.

Collect from the storage area, 30 mm thick RW5 insulation that has been cut to the size of the aluminum tray. Place this on top of the heater mat, in its bottom tray, and gently press into place. A small indentation will be made in insulation material by the cold leads. Remove the insulation from the frame, and gently relieve the insulation at this point.

Replace the insulation as before, ensuring that the cables now fit neatly into the insulation material. With the insulation pressed down carefully, cut off surplus cloth protruding above the aluminum frame.

Take the top aluminum tray and place it over the whole assembly, Squeeze assembly together with hand pressure and apply aluminum clamps to hold heater assembly in place during handling.

Transfer the whole assembly over to the compressing bench. Place one edge of the assembly along the clamping edge of the bench and remove temporary aluminum clamps along that edge. Apply clamping pressure along the whole edge.

Drill holes for pop rivets on 10″ centers (max) using a ⅛″ diameter stub, drill bit, taking care, to only just penetrate the aluminum frame. Insert ⅛″×⅜″ rivets into the holes in the tray and frame and rivet together.

Repeat 17 on the remaining edges until all rivets are installed.

While restraining module under the clamps, insert a pop rivet through the ring lug, the ground plate and into the frame next to the lead exit point.

When all rivets are completed, check edges of heaters for any slight distortion to the tray. Any distortion found can be gently removed using a soft face mallet. Loose fibers at the edges of the heaters should be removed using a sharp knife.

It will be understood that the forgoing description of the invention is by way of example only, and variations will be evident to those skilled in the art without departing from the scope of the invention.

What is claimed is:

1. An electrically powered ceiling heating device comprising:
a heating element, said heating element comprising at least one electrically resistive foil element; and,
at least one protective layer, said layer comprising chopped strands and resins.

2. The ceiling heating device of claim 1 in which said heating element comprises a plurality of resistive foil elements, each element constructed of a nichrome material and having a width of not greater than 0.125″ and thickness not greater than 0.0005″.

3. The ceiling heating device of claim 2 in which said nichrome material has an 80/20 ratio of nickel to chrome.

4. The ceiling heating device of claim 1, said device having an essential planar structure having a top surface and a bottom surface and consisting of layers, said layers comprising:
an upper chopped strand fiberglass mat positioned above the heating element;
a lower chopped strand fiberglass mat positioned below the heating element;
an upper metallic cover positioned above the upper chopped strand fiberglass mat;
a lower metallic cover positioned below the lower chopped strand fiberglass mat; and,
an insulation layer positioned between the upper chopped strand layer and the upper metallic cover

5. The ceiling heating device of claim 4 further comprising a high-temp cut out switch.

6. The ceiling heating device of claim 4 further comprising an adjustable thermostatic control device, said device capable of being located remotely from said ceiling heating device.

7. The ceiling heating device claim 4 wherein the device has exterior dimensions making it readily capable of being used in a ceiling as a replacement for a ceiling tile.

8. The ceiling heating device of claim 1 further comprising two layers of fiberglass cloth sewn together to thereby form a pocket for each of said least one electrically resistive foil element.

9. A method for constructing an electrically powered ceiling heating device, said device comprising a plurality of foil elements, said method comprising the step of:
creating a heating blanket element by sewing said foil elements between two layers of fiberglass cloth.

10. The method of claim 9 wherein said sewing step creates pockets in which foil elements reside.

11. The method of claim 9 wherein said foil elements are arranged electrically in a series/parallel configuration.

12. The method of claim 11 wherein said foil elements are constructed of a nichrome material having an 80/20 ratio of nickel to chrome.
